(19) United States
(12) Patent Application Publication
(10) Pub. No.: US 2015/0364226 A1
(43) Pub. Date: Dec. 17, 2015

(54) METHOD FOR THE SURFACE DECONTAMINATION OF COMPONENT PARTS OF THE COOLANT CYCLE OF A NUCLEAR REACTOR

(71) Applicant: AREVA GMBH, Erlangen (DE)

(72) Inventors: Luis SEMPERE BELDA, Erlangen (DE); Jose Pedro MOREIRA DO AMARAL, Fürth (DE); Christian TOPF, Forchheim (DE)

(21) Appl. No.: 14/650,543

(22) PCT Filed: Dec. 11, 2013
(86) PCT No.: PCT/EP2013/076155

§ 371 Date: Jul. 31, 2015

(30) Foreign Application Priority Data
Jan. 30, 2013 (DE) 10 2013 100 933.6

(51) Int. Cl. G21F 9/00

(52) U.S. Cl. CPC G21F 9/004

(57) ABSTRACT

The invention relates to a process for the chemical decontamination of a surface, having an oxide layer of a metallic component of the coolant system of a nuclear power station, which comprises at least one oxidation step in which the oxide layer is treated with an aqueous solution containing an oxidant and a subsequent decontamination step in which the oxide layer is treated with an aqueous solution of a decont. acid which has the property of forming a sparingly soluble precipitate with metal ions, in particular with nickel ions. Prior to carrying out the decontamination step, metal ions which have gone into solution during the oxidation step are removed from the aqueous solution by means of a cation exchanger.

The invention relates to a process for the surface decontamination of components of the coolant circuit of a nuclear reactor, i.e. a pressurized water reactor or boiling water reactor. The key part of the coolant circuit is a reactor pressure vessel in which fuel elements containing nuclear fuel are arranged. It is usual for a plurality of cooling loops each having a coolant pump to be arranged on the reactor pressure vessel.

Under the conditions of power operation of, for example, a pressurized water reactor having temperatures in the region of 300° C., even stainless austenitic FeCrNi steels, of which, for example, the piping system of the cooling loops consists, Ni alloys, of which, for example, the exchanger tubes of steam generators consist, and other materials used, for instance, for coolant pumps, e.g. cobalt-containing components, display some solubility in water. Metal ions leached from the alloys mentioned go in the coolant stream to the reactor pressure vessel where they are partly converted by the neutron radiation prevailing there into radioactive nuclides. The nuclides are in turn distributed by the coolant stream throughout the coolant system and are incorporated into oxide layers which are formed on the surfaces of components of the coolant system during operation. With increasing time of operation, the activated nuclides accumulate in and/or on the oxide layer, so that the radioactivity or the dose rate on the components of the coolant system increases. Depending on the type of alloy used for a component, the oxide layers contain, as main constituent, iron oxide having divalent and trivalent iron and oxides of other metals, in particular chromium and nickel, which are present as alloy constituents in the abovementioned steels. Here, nickel is always present in divalent form (Ni²⁺), and chromium is present in trivalent form (Cr³⁺).

Before monitoring, maintenance, repair and dismantling measures can be carried out on the coolant system, a reduction in the radioactive radiation of the respective components is necessary in order to reduce the radiation exposure of personnel. This is achieved by the oxide layer present on the surfaces of the components being removed as completely as possible by means of a decontamination process. In such a decontamination process, either the entire coolant system or a part separated therefrom by means of, for instance, valves is filled with an aqueous cleaning solution or individual components of the system are treated in a separate vessel containing the cleaning solution.

The oxide layer is, in the case of chromium-containing components, firstly treated oxidatively (oxidation step) and the oxide layer is subsequently dissolved under acidic conditions in what is known as a decontamination step by means of an acid, which will hereinafter be referred to as decontamination or decont. acid. The metal ions going into the solution during the treatment with a decont. acid are removed from the solution by the solution being passed over an ion exchanger. Any excess of oxidant present after the oxidation step is neutralized or reduced by addition of a reducing agent in a reduction step. The dissolution of the oxide layer or the leaching out of metal ions in the decontamination step thus occurs in the absence of an oxidant. The reduction of the excess oxidant can be an independent treatment step in which a reducing agent serving only for the purpose of reduction, for example ascorbic acid, citric acid or oxalic acid for the reduction of permanganate ions and manganese dioxide, is added to the cleaning solution. However, the reduction of excess oxidants can also be carried out within the decontamination step, in which case an amount of organic decontamination acid which is sufficient firstly to neutralize or reduce excess oxidant and secondly to bring about oxide dissolution is added. In general, a treatment or decontamination cycle comprising the treatment sequence “oxidation step-reduction step-decontamination step” or “oxidation step-decontamination step with simultaneous reduction” is carried out a number of times in order to achieve satisfactory decontamination or reduction of the radioactivity of the component surfaces. Decontamination processes of the above-described type are known, for example, under the name CORD (chemical oxidation, reduction and decontamination).

The oxidative treatment of the oxide layer is necessary because chromium(III) oxides and mixed oxides containing trivalent chromium, especially of the spinel type, are only sparingly soluble in the decont. acids which come into question for decontamination. To increase the solubility, the oxide layer is therefore firstly treated with an aqueous solution of an oxidant such as Ce⁴⁺, HMnO₄, H₂S₂O₈, KMnO₄, KMnO₄ with acid or alkali or ozone. The result of this treatment is that Cr(III) is oxidized to Cr(VI) which goes into solution as CrO₄²⁻.

Owing to the presence of a reducing agent in the decont. step, which is always the case when an organic decontamination acid is used, the Cr(VI) formed in the oxidation step, which is present as chromate in the aqueous solution, is reduced further to Cr(III). At the end of a decont. step, essentially Cr(III), Fe(II), Fe(III), Ni(II) and also radioactive isotopes such as Co-60 are present in the cleaning solution. These metal ions can be removed from the cleaning solution by means of an ion exchanger. One decont. acid which is frequently used in the decont. step is oxalic acid because it enables the oxide layers to be removed from component surfaces to be dissolved effectively.

However, it is a disadvantage that some decont. acids, in particular including oxalic acid, form sparingly soluble precipitates, in the case of oxalic acid, to which reference will be made by way of example below, oxalate precipitates, with divalent metal ions such as Ni²⁺, Fe²⁺and Co²⁺. The precipitates mentioned can be distributed throughout the entire coolant system and deposit on the interior surfaces of pipes and of components, for example steam generators. In addition, the precipitates make it difficult to carry out the total process.

A further disadvantage is that in the course of the formation of, in particular, oxalate precipitates, coprecipitation of radio nuclides present in the aqueous solution and thus recontamination of the component surfaces occurs. The risk of recontamination is particularly great in the case of components having a large ratio of surface area to volume. This is, in particular, the case for steam generators which have a very large number of exchanger tubes having a small diameter. Furthermore, recontamination preferentially occurs in zones of low flow.

A further disadvantage of the formation of oxalate precipitates and other precipitates is that they can block filter devices, for example the filters upstream of an ion exchanger, and sieve trays or the protective filters of circulation pumps. Finally, a further disadvantage occurs when an above-described treatment cycle comprising an oxidation step and a decont. step is repeated, i.e. when a decont. step is followed by a renewed oxidation step. If precipitates had been formed in the preceding decont. step, the corresponding metal ions, for instance Ni in the case of a nickel oxalate precipitate, cannot be removed from the cleaning solution by means of ion exchangers. The consequence is that the oxalate radical of the precipitate is oxidized to carbon dioxide and water in the subsequent oxidation step and oxidant is thereby consumed without useful purpose. If, on the other hand, the oxalate is present in solution, i.e. is not bound in the form of a precipitate, the oxalate can be destroyed, i.e. converted into carbon dioxide and water, in a simple way, for instance before the purification solution is conveyed into an ion exchanger, in a simple and inexpensive manner, for example by means of UV light.

When precipitates of the above-described type have arisen during a decontamination process, a great outlay in terms of time and money is necessary to remove these again at least partly from an aqueous solution or a coolant system to be decontaminated and be able to continue the decontamination process. Attempts have therefore been made in the past to increase the rate of removal of nickel from the aqueous solution during the decont. step by means of a correspondingly large exchanger capacity. This is possible to only a restricted extent, for technical reasons, in the cleaning or decontamination of relatively large systems, for example the complete coolant circuit.

Proceeding therefrom, it is an object of the invention to propose a decontamination process which is improved in respect of the disadvantages indicated.

This object is achieved in a decontamination process of the type mentioned at the outset by metal ions which have gone over into the aqueous solution during the oxidation step being removed from the solution by means of a cation exchanger before the decontamination step is carried out, i.e. before the addition of an organic decont. acid. For this purpose, the aqueous solution is, in a manner which is advantageous from a process engineering point of view, passed over a cation exchanger. The removal of nickel is particularly advantageous here since this forms particularly sparingly soluble salts or precipitates with organic acids.

When the oxide layer is then treated with a decont. acid in a subsequent decont. step, as indicated above, and metal ions are dissolved to a great extent from the oxide layer, the metal ion concentrations established are lower than in conventional decontamination processes since at least part of the metal ions which have gone into solution in the oxidation step have been removed beforehand and are therefore no longer present in the solution. The risk of the solubility product of a metal salt of a decont. acid (the product of the activities of the metal cation and of the acid anion) being exceeded and a sparingly soluble precipitate being formed is thus reduced. Particularly in the case of nickel and oxalic acid, the formation of sparingly soluble nickel oxalate precipitate is critical since nickel oxalate has a relatively low solubility product.

Since ion exchangers are generally organic in nature, they are sensitive to oxidants, in particular to the permanganic acid or alkali metal salts thereof, which are very strong oxidants which are preferably used in a process according to the invention. It is therefore advantageous, especially in the case of organic ion exchangers, to neutralize an oxidant still present in the aqueous solution by means of a reducing agent before the solution is passed over the cation exchanger to remove metal ions.

The decont. acid used in the subsequent decont. step is preferably used as reducing agent. Here, it is advantageous that this acid is in any case available on site, so that an additional outlay for, for instance, procurement and storage and for additional approval which would be necessary if a reducing agent, for instance glyoxylic acid, different from the decont. acid were to be used is not necessary.

A process according to the invention can, for example, be utilized for decontamination of the entire coolant system or part of the coolant system of a nuclear reactor, for example a boiling water reactor.

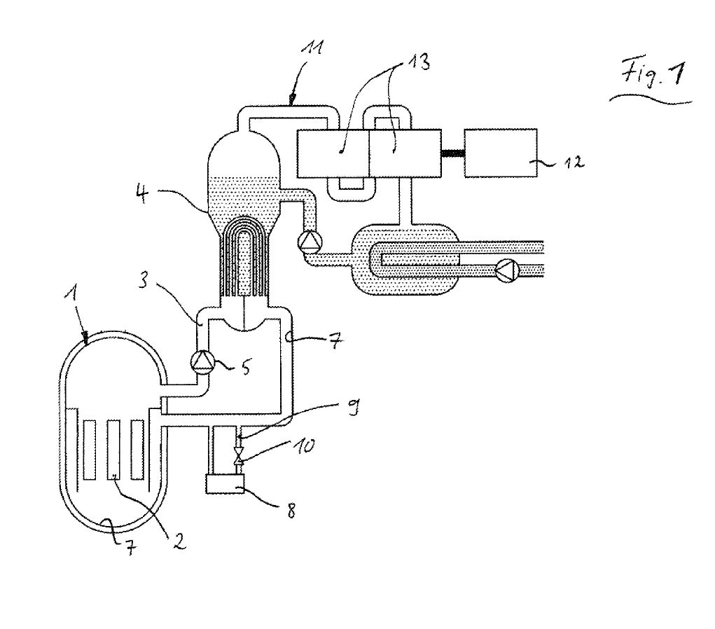

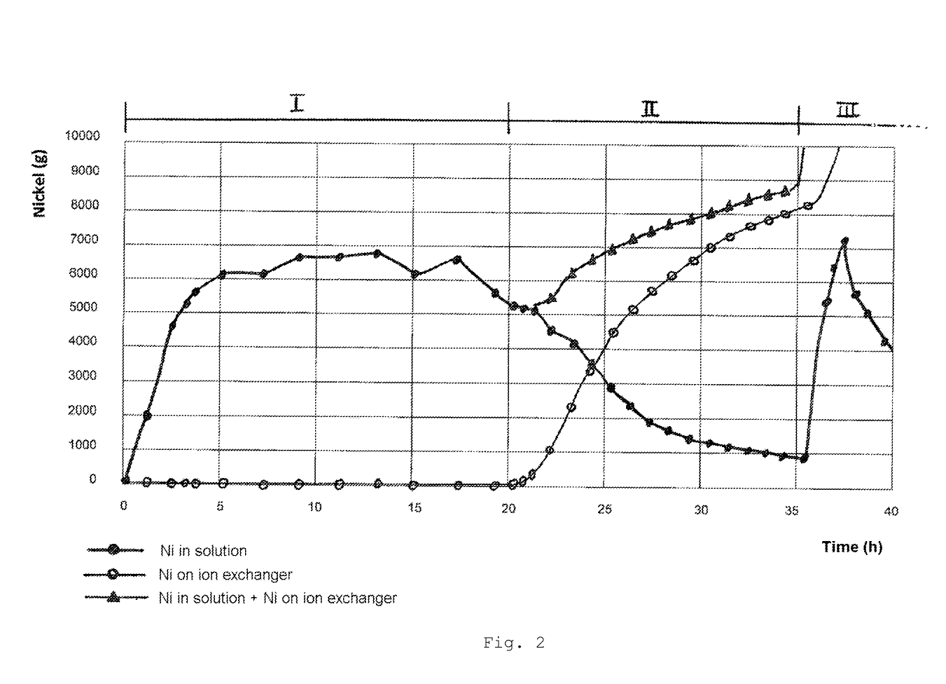

The accompanying drawing FIG. 1 schematically shows the coolant system or the primary circuit of a pressurized water reactor. It comprises the pressure vessel 1, in which a plurality of fuel elements 2 are present, at least during operation, and also a line system 3 which is connected to the pressure vessel 1 plus various installations such as a steam generator 4 and a coolant pump 5. The secondary circuit 11, which comprises, inter alia, a steam turbine 13 driving a generator 12, is likewise shown in FIG. 1. The object of the cleaning or decontamination in question is to dissolve an oxide layer present on the interior surfaces 7 of the components of the primary circuit and to remove the constituents thereof which have gone into solution from the aqueous solution. The entire coolant system is filled with an aqueous solution containing, for example, a complexing organic acid such as oxalic acid, to which reference will be made by way of example in the following. When filling is spoken of here, this should be taken to include a process in which the coolant present in the coolant system after shutdown of power operation, i.e. after running-down of the plant, forms the aqueous solution in question, with an oxidant, preferably permanganic acid or potassium permanganate, being added to this in order to carry out the oxidation step. In the case of complete decontamination, the entire cooling system is filled; otherwise, only parts, for example only a section of the line system, can be treated.

The use of the process of the invention in the decontamination of the complete coolant system of a pressurized water reactor will now be described below, with only the first cleaning cycle will be considered.

The oxidation was carried out in aqueous solution using permanganic acid as oxidant in a concentration of about 200 ppm at a temperature of about 90° C. As can be seen from the attached graph, the concentration or amount of nickel ions rose during the oxidation step (I) to a value in the range from 6000 g over a period of about 10 hours and then remained essentially constant. After about 17 hours from the beginning of the oxidation step, a slightly superstoichiometric amount of oxalic acid was introduced as reducing agent into the aqueous solution in order to neutralize permanganic acid which had not been consumed. After a time of about 3 hours to allow the reducing agent to act, the removal of the nickel ions (II) and naturally also other metal ions was commenced at the time point 20 hours by connecting in the cation exchanger 8, i.e. the valve 10 of the bypass 9 was opened so that a substream of the aqueous solution circulating in the coolant system was conveyed over the cation exchanger 8, which is indicated in a highly schematic and technically simplified manner in FIG. 1.

As can be seen from the graph, nickel is held back by the cation exchanger so that the amount or concentration thereof in the overall system decreases correspondingly. In the present example, the amount of nickel dissolved in the aqueous solution during the nickel removal (II) asymptotically approaches a lower value of about 500 g.

At this point in time, i.e. after about 35 hours after commencement of the cleaning cycle, the decont. step (III) was started by introduction of oxalic acid. The introduction was carried out in such a way that an oxalic acid concentration of 2000 ppm was not exceeded in the solution. It can be seen from the graph that the amount of nickel firstly increased greatly as a result of dissolution of the oxide layer, but then decreased as a result of the connected cation exchanger 8. If the amount of nickel formed in phase I had not been removed according to the invention, there would not have been an amount of nickel of about 7000 g in the solution in phase III but instead there would have been a significantly higher total amount of nickel in the solution of about 13000 g, which would have led to solubility problems and the risk of precipitates.

1. A process for the chemical decontamination of a surface having an oxide layer of a metallic component of the coolant system of a nuclear power station, which comprises at least one oxidation step in which the oxide layer is treated with an aqueous solution containing an oxidant and a subsequent decontamination step in which the oxide layer is treated with an aqueous solution of a decontamination acid which has the property of forming a sparingly soluble precipitate with metal ions, in particular with nickel ions, characterized in that metal ions which have gone into solution during the oxidation step are removed from the aqueous solution by means of a cation exchanger before the decontamination step is carried out.

2. The process as claimed in claim 1, characterized in that a reduction step in which an oxidant present in the aqueous solution is neutralized by means of a reducing agent is carried out before the removal of the metal ions.

3. The process as claimed in claim 2, characterized in that the decontamination acid used in the subsequent decontamination step is used as reducing agent.

4. The process as claimed in claim 2, characterized in that at least part of the aqueous solution is passed over a cation exchanger and metal ions present in the aqueous solution are thus removed.

5. The process as claimed in claim 1, characterized in that permanganic acid or a salt of permanganic acid is used in the oxidation step.

6. The process as claimed in claim 5, characterized by the use of oxalic acid as decontamination acid.
